(19) United States
(12) Patent Application Publication
(10) Pub. No.: US 2012/0327514 A1
(43) Pub. Date: Dec. 27, 2012

(54) DIFFRACTIVE OPTICAL ELEMENT AND IMAGING APPARATUS USING THE SAME

(75) Inventors: Toshiaki TAKANO, Osaka (JP); Tomokazu TOKUNAGA, Hyogo (JP); Tetsuya SUZUKI, Osaka (JP); Koji FUJII, Osaka (JP)

(73) Assignee: PANASONIC CORPORATION, Osaka (JP)

(21) Appl. No.: 13/530,222

(22) Filed: Jun. 22, 2012

(30) Foreign Application Priority Data
Jun. 23, 2011 (JP) 2011-139091
May 21, 2012 (JP) 2012-115735

(51) Int. Cl. G02B 5/18

(52) U.S. Cl. 359/576

(57) ABSTRACT

A diffractive optical element includes a first optical member, a second optical member, and a third optical member stacked on each other in this order. A diffractive surface including a plurality of raised parts is formed at an interface between the first and second optical members. The third optical member contacts at least one of the raised parts.

### CROSS-REFERENCE TO RELATED APPLICATION

This application claims priority to Japanese Patent Application No. 2011-139091 filed on Jun. 23, 2011 and Japanese Patent Application No. 2012-115735 filed on May 21, 2012, the disclosure of which including the specification, the drawings, and the claims is hereby incorporated by reference in its entirety.

### TECHNICAL FIELD

The instant application relates to a diffractive optical element and an imaging apparatus including the diffractive optical element.

### BACKGROUND

Conventionally, a diffractive optical element in which several optical members are stacked so as to closely contact each other and a relief pattern is formed at an interface between the optical members has been known.

For example, a diffractive optical element of Japanese Patent Publication No. H9-127321 is configured such that several optical members are stacked on each other and a boundary surface between the optical members is formed by a diffractive grating having a serrated cross-sectional shape.

For manufacturing the diffractive optical element of this type, the optical member having a diffractive surface and made of a glass material is formed, and, e.g., an ultraviolet curable resin material is applied onto the diffractive surface. The resin material is irradiated with ultraviolet light and is cured, and therefore a resin layer is formed. However, in the diffractive optical element manufactured in the foregoing manner, a surface of the resin layer on an opposite side of the diffractive surface may be corrugated in accordance with the shape of the diffractive surface.

In one general aspect, the instant application describes a diffractive optical element in which a corrugated surface is less likely to be formed in accordance with the shape of a diffractive surface and variation in thickness of a resin layer is reduced.

### SUMMARY

A diffractive optical element of the instant application includes a first optical member, a second optical member, and a third optical member stacked on each other in this order. A diffractive surface including a plurality of raised parts is formed at an interface between the first and second optical members, and the third optical member contacts at least one of the raised parts.

### BRIEF DESCRIPTION OF THE DRAWINGS

FIG. 1 is a schematic cross-sectional view illustrating a diffractive optical element.

FIG. 2 is an enlarged cross-sectional view of part of the diffractive optical element.

FIGS. 3A-3E are views schematically illustrating steps for manufacturing the diffractive optical element.

FIG. 4 is an enlarged cross-sectional view of part of a diffractive optical element of a first variation.

FIG. 5 is an enlarged cross-sectional view of part of a diffractive optical element of a second variation.

FIG. 6 is an enlarged cross-sectional view of part of a diffractive optical element of a third variation.

FIG. 7 is a schematic cross-sectional view of an imaging apparatus.

### DETAILED DESCRIPTION

In the following detailed description, numerous specific details are set forth by way of examples in order to provide a thorough understanding of the relevant teachings. However, it should be apparent to those skilled in the art that the present teachings may be practiced without exemplary details. In other instances, well-known methods, procedures, components, and/or circuitry have been described at a relatively high-level, without detail, in order to avoid unnecessarily obscuring aspects of the present concepts.

### First Embodiment

### Configuration

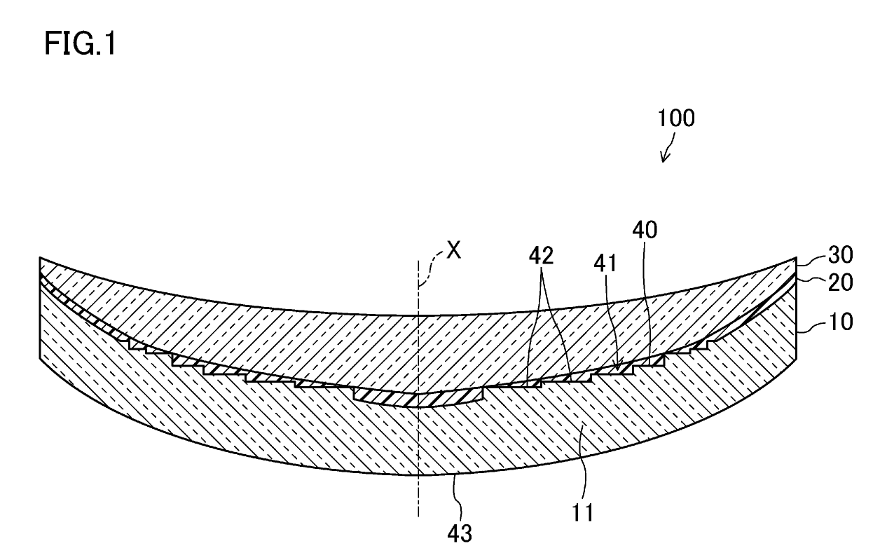

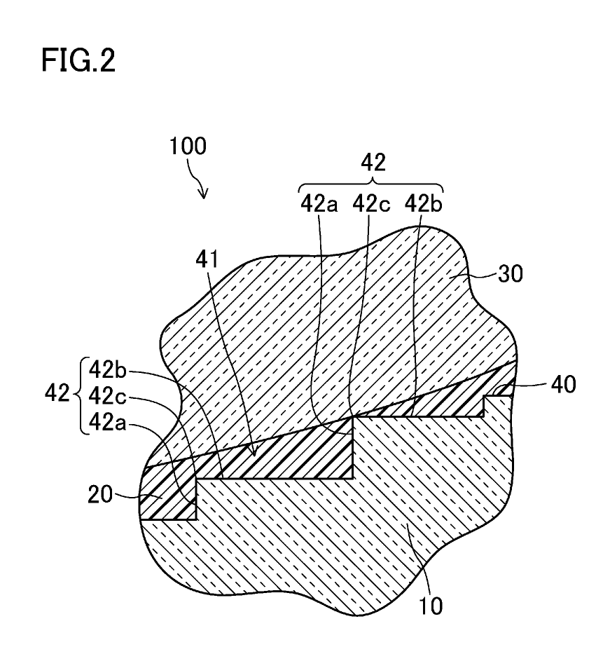

FIG. 1 illustrates a schematic cross-sectional view of a diffractive optical element 100, and FIG. 2 illustrates an enlarged cross-sectional view of part of the diffractive optical element 100.

The diffractive optical element 100 is a multilayer diffractive optical element in which a first optical member 10, a second optical member 20, and a third optical member 30 are stacked in this order so as to closely contact each other. Each of the first to third optical members 10, 20, 30 has light permeability. Specifically, the first and third optical members 10, 30 are made of a glass material. The second optical member 20 is made of a resin material. Note that the first and third optical members 10, 30 may be made of the same glass material, or may be made of different glass materials. Alternatively, the first and third optical members 10, 30 may be made of the same material as that of the second optical member 20.

The first and second optical members 10, 20 are coupled together. The first optical member 10 has two optical surfaces. One of the optical surfaces of the first optical member 10 is a diffractive surface 40 having a diffractive grating 41. The other optical surface 43 is an aspherical surface. Note that the optical surface 43 is not limited to the aspherical surface, and may be, e.g., a flat surface, a spherical surface, or a diffractive surface.

The second optical member 20 is coupled to the diffractive surface 40 of the first optical member 10. A surface of the second optical member 20 coupled to the first optical member 10 is in a shape similar to that of the diffractive surface 40. That is, the diffractive surface 40 is formed at an interface between the first and second optical members 10, 20. Since optical power of the diffractive surface 40 has dependence on wavelength, the diffractive surface 40 gives substantially the same phase difference to light having different wavelengths to diffract the light having different wavelengths at different diffraction angles.

The third optical member 30 is coupled to a surface of the second optical member 20 on an opposite side of the surface of the second optical member 20 coupled to the first optical member 10. That is, the second optical member 20 is sandwiched between the first and third optical members 10, 30. The third optical member 30 has two optical surfaces. One of the optical surfaces is coupled to the second optical member 20. Each of the optical surfaces may be an aspherical surface. Note that the optical surface may be, e.g., a spherical surface, a flat surface, or a diffractive surface. In addition, each of the optical surfaces is in a different shape, or the optical surfaces may be in the same shape.

Next, the first optical member 10 will be described in more detail.

The first optical member 10 includes a base part 11 and the diffractive grating 41 integrally formed with the base part 11. The diffractive grating 41 is formed in a recessed-raised shape having periodicity.

The diffractive grating 41 includes a plurality of raised parts 42 each having a circular shape as viewed in plane and extending in a circumferential direction around an optical axis X of the diffractive optical element 100. In plan view, the plurality of raised parts 42 are regularly arranged in a concentric pattern around the optical axis X such that each forms a ring with a different diameter around the optical axis X. Each of the raised parts 42 includes a first surface 42a substantially parallel to the optical axis X (i.e., extending along the optical axis X), a second surface 42b mainly having a diffraction function, and a ridged part 42c connecting between the first and second surfaces 42a, 42b. In addition, each of the raised parts 42 has a substantially triangular cross section. The second surface 42b tilts to the optical axis X or faces toward the optical axis X. The ridged part 42c is one example of a connection part. The second surface 42b may be curved in an aspherical shape or a spherical shape.

At least some of the plurality of raised parts 42 contact the third optical member 30 at the ridged parts 42c. Specifically, two of the raised parts 42 contact the third optical member 30. Since the raised part 42 is in the circular shape, FIG. 1 illustrates the diffractive optical element 100 as if the third optical member 30 contacts the raised parts 42 at four points. The height of some of the raised parts 42 is increased, and therefore only such raised parts 42 contact the third optical member 30. The other raised parts 42 are apart from the third optical member 30. The raised parts 42 contact the third optical member 30 not at the first and second surfaces 42a, 42b, but at the ridged parts 42c.

Note that the diffractive optical element 100 may be configured such that all of the raised parts 42 contact the third optical member 30 at the ridged parts 42c.

By allowing the contact of the raised parts 42 to the third optical member 30, a relationship between the positions of the first and third optical members 10, 30 in an optical axis direction is determined. That is, a clearance is formed between the third optical member 30 and each of the raised parts 42 of the first optical member 10 which do not contact the third optical member 30, and is filled with the second optical member 20. Since the third optical member 30 contacts the raised parts 42, variation in distance between the first and third optical members 10, 30 in the optical axis direction, i.e., variation in thickness of the second optical member 20 can be reduced.

Manufacturing Method

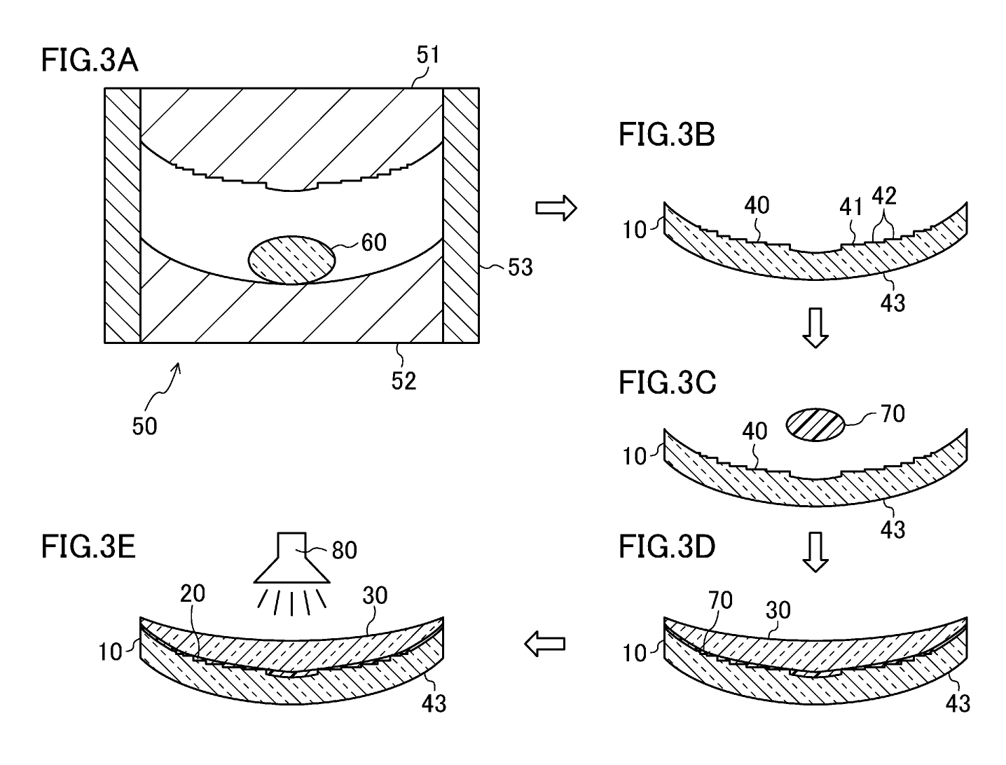

Next, a method for manufacturing a diffractive optical element 100 will be described. FIGS. 3A-3E schematically illustrate steps for manufacturing the diffractive optical element 100.

First, a mold 50 is prepared. The mold 50 includes an upper mold part 51, a lower mold part 52, a mold body 53. A molding surface of the upper mold part 51 has an inverted shape relative to the shape of a diffractive grating 41.

A base material of the upper mold part 51 is, e.g., cemented carbide or a ceramic material such as SiC. For example, a DLC film may be formed on the molding surface of the upper mold part 51 for detachability of the mold 50 from a glass material. As processing for forming the inverted shape relative to the shape of the diffractive grating 41, mechanical control processing such as grinding or cutting can be used to freely form a desired shape.

The mold 50 is filled with a glass material, and pressure is applied to the mold 50. Specifically, referring to FIG. 3A, an optical glass material 60 (e.g., a material manufactured as a product name of “VC79” by Sumita Optical Glass Inc. and having a Tg temperature of 516° C. and an At temperature of 553° C.) is applied onto a molding surface of the lower mold part 52, and then is heated to a desired temperature (e.g., about 580° C.) equal to or higher than the At temperature. Subsequently, a pressure device downwardly moves the upper mold part 51 along the mold body 53 to apply pressure to the optical glass material 60 (e.g., apply pressure of 200 kg for 40 seconds) and deform the optical glass material 60. Then, the optical glass material 60 is cooled to a predetermined temperature (e.g., 510° C.) close to the Tg temperature, and the upper mold part 51 is detached when the temperature of the optical glass material 60 reaches a temperature (e.g., 50-100° C.) at which the optical glass material 60 is removable. In the foregoing manner, a first optical member 10 is formed.

FIG. 3B illustrates the first optical member 10 formed in the foregoing manner. For example, the first optical member 10 has the following dimensions: an outer diameter φ of 38 mm; a thickness t of 4 mm; a radius of curvature of 100 mm for a base surface (surface formed by removing a diffractive grating 41 from a diffractive surface 40); and a radius of curvature of 50 mm for an optical surface 43 on an opposite side of the base surface.

Meanwhile, an optical glass material (e.g., a material manufactured as a product name of “S-FTM16” by Ohara Inc.) is formed into a third optical member 30 by polishing.

Next, referring to FIG. 3C, a resin material 70 (e.g., a material manufactured as a product name of “UV Epoxy Resin A-1631” by TESK Co., Ltd) is applied onto the diffractive surface 40 of the first optical member 10.

Referring to FIG. 3D, the third optical member 30 is pressed against the resin material 70 from above, thereby spreading the resin material 70 thin. After a while, the third optical member 30 comes into contact with at least one of raised parts 42 of the diffractive grating 41 at a ridged part(s) 42c. This determines a distance between the first and third optical members 10, 30. As a result, the thickness of the resin material 70 (second optical member 20) is determined.

Some of the ridged parts 42c of the raised parts 42 (hereinafter referred to as “contact raised parts 42”) of the first optical member 10 are closer to the third optical member 30 than the other ridged parts 42c of the raised parts 42 (hereinafter referred to as “non-contact raised parts 42”) are. Thus, the non-contact raised parts 42 do not contact the third optical member 30.

Next, referring to FIG. 3E, the resin material 70 is irradiated with ultraviolet light (e.g., a wavelength of 365 nm and an intensity of 50 mW) for 60 seconds by an ultraviolet light emitting device 80, and is cured. Subsequently, heat treatment is applied to the resin material 70 at 110° C. for 30 minutes in order to accelerate curing of the resin material 70. In the foregoing manner, a diffractive optical element 100 in which the first to third optical members 10, 20, 30 are stacked on each other is manufactured.

Advantages

In the diffractive optical element 100, the first to third optical members 10, 20, 30 are stacked on each other in this order. The diffractive surface 40 including the plurality of raised parts 42 is formed at the interface between the first and second optical members 10, 20, and the third optical member 30 contacts at least one of the raised parts 42.

If only the first and second optical members 10, 20 form the diffractive optical element, there is a possibility that the surface of the second optical member 20 on the opposite side of the diffractive surface 40 is corrugated in accordance with the shape of the diffractive surface 40. Considering the foregoing case, by further stacking the third optical member 30 on the second optical member 20, the foregoing corrugation in the diffractive optical element 100 can be reduced.

However, in the diffractive optical element including the plurality of layers, if the thickness of each of the layers varies, the thickness of the entirety of the diffractive optical element also varies. Particularly in the diffractive optical element in which at least three layers are stacked on each other, it is likely that the thickness of the middle layer (second optical member 20) varies. Considering the foregoing case, by allowing the contact between the first and third optical members 10, 30 at the raised part(s) 42, the variation in distance between the first and third optical members 10, 30 can be reduced, and therefore the variation in thickness of the second optical member 20 can be reduced. As a result, the high-grade diffractive optical element 100 can be easily manufactured with high positional accuracy of the first and third optical members 10, 30 and high thickness accuracy of the second optical member 20.

Each of the raised parts 42 includes the first surface 42a, the second surface 42b, and the ridged part 42c connecting between the first and second surfaces 42a, 42b. The third optical member 30 contacts the ridged part(s) 42c.

According to the foregoing configuration, the diffraction function of the diffractive surface 40 can be properly fulfilled. Specifically, on the precondition that mediums sandwiching the second surfaces 42b are the first and second optical members 10, 20, the second surfaces 42b are designed to fulfill a desired diffraction function. For the foregoing reason, if the second surfaces 42b and the third optical member 30 contact each other, the mediums sandwiching the second surfaces 42b are the first and third optical members 10, 30 at the contact point of the second surfaces 42b and the third optical member 30, and therefore the diffraction function of the second surfaces 42b cannot be properly fulfilled. Considering the foregoing case, by allowing the contact between the first and third optical members 10, 30 at the ridged part(s) 42c of the raised part(s) 42, the third optical member 30 and the second surfaces 42b do not contact each other. As a result, the second surfaces 42b can properly fulfill the diffraction function.

Note that, it can be easily checked by observing the cross section of the diffractive optical element 100 with a stereomicroscope or an electronic microscope (e.g., a microscope manufactured as a product name of “OLS 1200” by Olympus Corporation) whether or not the first and third optical members 10, 30 contact each other at the raised part(s) 42.

Variations

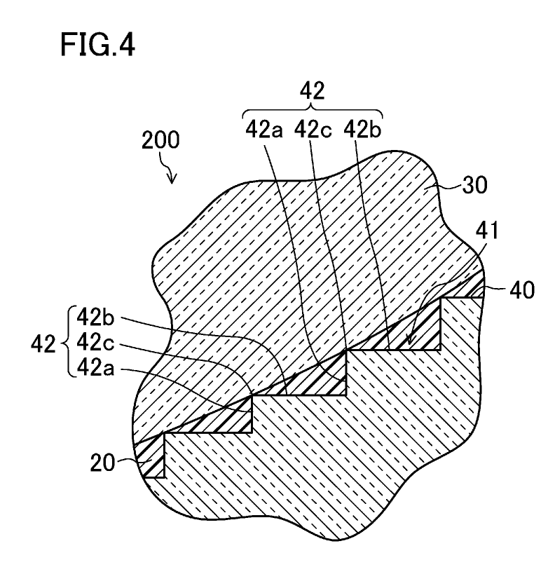

Next, a diffractive optical element 200 of a first variation will be described with reference to FIG. 4. FIG. 4 illustrates an enlarged cross-sectional view of part of the diffractive optical element 200 of the first variation.

In the diffractive optical element 100, some of the plurality of raised parts 42 contact the third optical member 30. However, in the diffractive optical element 200, all of raised parts 42 contact a third optical member 30 at ridged parts 42c.

According to the foregoing configuration, a second optical member 20 can be formed thin, and therefore the diffractive optical element 200 can be also formed thin. That is, in the diffractive optical element 100, the contact raised parts 42 are necessarily arranged closer to the third optical member 30 than the non-contact raised parts 42 are such that the non-contact raised parts 42 do not contact the third optical member 30. As the height of the contact raised part 42 increases, the distance between the first and third optical members 10, increases, and the thickness of the second optical member 20 increases accordingly. Thus, the thickness of the second optical member 20 is increased. On the other hand, since all of the raised parts 42 contact the third optical member 30 in the diffractive optical element 200, it is not necessary that the contact raised parts 42 are arranged closer to the third optical member 30 than the non-contact other raised parts 42 are. Thus, since the distance between the first and third optical members 10, 30 is shorter in the diffractive optical element 200 than in the diffractive optical element 100, the thickness of the second optical member 20 can be reduced.

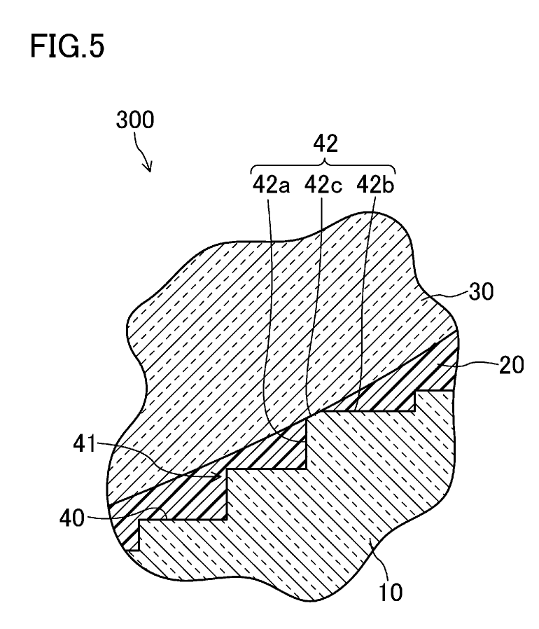

Next, a diffractive optical element 300 of a second variation will be described with reference to FIG. 5. FIG. 5 is an enlarged cross-sectional view of part of the diffractive optical element 300 of the second variation.

In the diffractive optical element 300, some of a plurality of raised parts 42 contact a third optical member 30. In this regard, the diffractive optical element 300 is similar to the diffractive optical element 100. However, in the diffractive optical element 300, each of the raised parts 42 contacting the third optical member 30 includes a first surface 42a, a second surface 42b, and a connection surface 42d connecting between the first and second surfaces 42a, 42b. That is, the raised part 42 is in such a shape that a ridged part formed by the first and second surfaces 42a, 42b is chamfered. The connection surface 42d is formed in a curved shape along a surface of part of the third optical member 30 contacting the connection surface 42d. In other words, as viewed in a cross section of the raised part 42, the connection surface 42d is defined by a curved line. Thus, the connection surface 42d and the third optical member 30 are in surface contact with each other. The connection surface 42d is an example of the connection part.

A first optical member 10 including the connection surfaces 42d can be manufactured by a method similar to the method for manufacturing the diffractive optical element 100. That is, an inverted shape relative to the shape of a diffractive grating 41 including the connection surfaces 42d may be formed in an upper mold part 51 by machine processing.

According to the foregoing configuration, the yield rate of the diffractive optical element 300 can be improved. That is, depending on the hardness and strength of an optical glass material used for the first or third optical member 10, 30, there is a possibility that, when the raised parts 42 come into contact with the third optical member 30, the raised part(s) 42 may be cracked or a surface of the third optical member 30 may be scratched. In such a situation, the production yield rate is reduced.

On the other hand, according to the diffractive optical element 300, since part of the raised part 42 contacting the third optical member 30 is chamfered, the cracks of the raised part(s) 42 or the scratches of the third optical member 30 can be reduced or prevented. As a result, the high-yield diffractive optical element can be manufactured with high positional accuracy of the first and third optical members 10, 30 and high thickness accuracy of a second optical member 20.

Note that the shape of the connection surface 42d is not limited to the foregoing shape. For example, the connection surface 42d is not necessarily in the shape along the surface of part of the third optical member 30 contacting the connection surface 42d. That is, the connection surface 42d may be a surface formed by simply chamfering the raised part 42. Alternatively, the connection surface 42d may be a surface defined by a straight line as viewed in the cross section of the raised part 42, i.e., a C-chamfered surface. As another alternative, the connection surface 42d may be a surface defined by an arc as viewed in the cross section of the raised part 42, i.e., an R-chamfered surface.

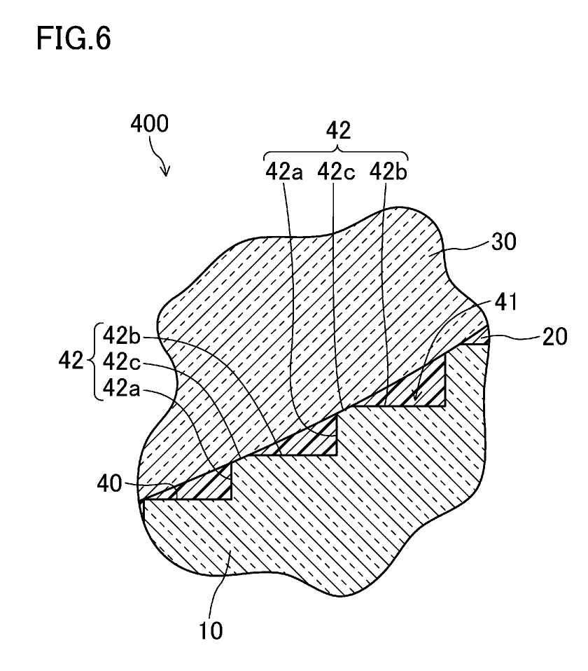

Next, a diffractive optical element 400 of a third variation will be described. FIG. 6 is an enlarged cross-sectional view of part of the diffractive optical element 400 of the third variation.

In the diffractive optical element 300, some of the plurality of raised parts 42 contact the third optical member 30. However, in the diffractive optical element 400, all of raised parts 42 contact a third optical member 30 at connection surfaces 42d. That is, as in the similarity between the diffractive optical element 100 and the diffractive optical element 200, the diffractive optical element 400 is similar to the diffractive optical element 300.

According to the foregoing configuration, a second optical member 20 can be formed thin as in the diffractive optical element 200. In addition, as in the diffractive optical element 300, cracks of the raised part(s) 42 or scratches of the third optical member 30 can be reduced or prevented, and therefore the high-yield diffractive optical element can be manufactured with high positional accuracy of the first and third optical members 10, 30 and high thickness accuracy of the second optical member 20.

### Second Embodiment

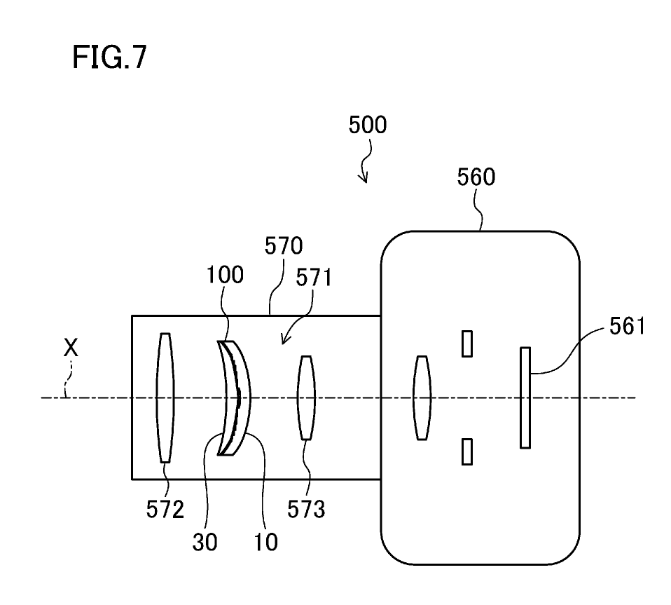

Next, a camera 500 of a second embodiment will be described with reference to a drawing. FIG. 7 illustrates a schematic view of the camera 500.

The camera 500 includes a camera body 560 and an interchangeable lens 570 coupled to the camera body 560. The camera 500 is an example of an imaging apparatus.

The camera body 560 includes an imaging element 561.

The interchangeable lens 570 is detachable from the camera body 560. The interchangeable lens 570 is, e.g., a telephoto zoom lens. The interchangeable lens 570 includes an imaging optical system 571 for focusing a light bundle on the imaging element 561 of the camera body 560. The imaging optical system 571 includes the diffractive optical element 100 and refracting lenses 572, 573. The diffractive optical element 100 functions as a lens element. The interchangeable lens 570 serves as an optical unit.

### Other Embodiments

The instant application is not limited to the foregoing embodiments, and suitable modifications, substitutions, additions, omissions, etc. may be made. Different aspects and elements of the embodiments may be combined to form another embodiment.

For example, each of the foregoing embodiments may have the following configurations.

As in the diffractive optical elements 100, 300, in the configuration in which some of the plurality of raised parts 42 contact the third optical member 30, the number of the raised parts 42 contacting the third optical member 30 may be set to any number.

The materials of the first to third optical members 10, 20, 30 are not limited to the foregoing materials. For example, thermo-plastics may be used as the materials of the first and third optical members 10, 30.

An anti-reflection film may be formed on the diffractive surface 40 of the first optical member 10. That is, part of the diffractive surface on which the anti-reflection film is formed may contact the third optical member 30.

The base surface formed by removing the diffractive grating 41 from the diffractive surface 40 is formed in the spherical shape, but the instant application is not limited to such a base surface. The base surface of the diffractive surface 40 may be an aspherical surface or a flat surface.

The instant application is useful for the diffractive optical element including the diffractive surface and the imaging apparatus including the diffractive optical element.

It is understood that various modifications may be made in the foregoing embodiments, that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A diffractive optical element, comprising:
a first optical member, a second optical member, and a third optical member stacked on each other in this order,
wherein a diffractive surface including a plurality of raised parts is formed at an interface between the first and second optical members, and
the third optical member contacts at least one of the raised parts.

2. The diffractive optical element of claim 1, wherein
each of the raised parts includes a first surface, a second surface, and a connection part connecting between the first and second surfaces, and
the third optical member contacts at least one of the connection parts of the raised parts.

3. The diffractive optical element of claim 2, wherein
the connection part is a ridged part formed by the first and second surfaces.

4. The diffractive optical element of claim 2, wherein
the connection part has a surface.

5. The diffractive optical element of claim 4, wherein
the surface is defined by a curved line as viewed in a cross section of the raised parts.

6. The diffractive optical element of claim 4, wherein
the surface is defined by a straight line as viewed in a cross section of the raised parts.

7. An imaging apparatus, comprising:
the diffractive optical element of claim 1.
